(19) United States
(12) Patent Application Publication
(10) Pub. No.: US 2010/0146101 A1
(43) Pub. Date: Jun. 10, 2010

(54) Method And System For Binding A Watcher Representing A Principal To A Tuple Based On A Matching Criterion

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/330,543

(22) Filed: Dec. 9, 2008

(51) Int. Cl. G06F 15/16; G06F 17/30

(52) U.S. Cl. 709/224; 707/E17.002

(57) ABSTRACT

Methods, systems and computer program products are described for dynamically binding a watching principal to a tuple. In one aspect, a system comprises a message router component configured to receive a watcher matching criterion to bind a watcher representing a principal to a tuple, and an attribute manager component configured to receive an attribute of a first principal represented by a first watcher in a publish/subscribe client. The system also includes a matcher component configured to determine whether the first watcher satisfies the watcher matching criterion when an update to a tuple is detected, where the determination is based on an evaluation of the watcher matching criterion and the attribute of the first principal, and a binder component configured to bind the first watcher to the updated tuple by providing at least a portion of the updated tuple information to the first watcher when the matching criterion is satisfied.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

One mode of exchanging information over the Internet uses a publish/subscribe (pub/sub), asynchronous, communication protocol. The commands of an asynchronous protocol, such as a pub/sub communication protocol, are structured such that there need not be a one-to-one correspondence between messages exchanged between communication entities. In some cases a publisher of information via the protocol need not wait for, nor expect, a response from a receiver of a message. Moreover, a receiver need not send a request for each message received. That is, a receiver may receive multiple messages associated with a sent message and/or may receive an unsolicited message. Thus, unlike a request/response, synchronous protocol where the response is sent directly (synchronously) and only in response to the entity's request, the information can instead be sent to a receiver in the absence of a corresponding request from the receiver (i.e., asynchronous to any request for information).

According to pub/sub communication protocols, a pub/sub service can receive published information from a publisher and asynchronously deliver such information to receivers. Typically, the pub/sub service stores and organizes such information in a data entity known as a tuple, which in its broadest sense, is a data object containing one or more tuple elements into which information is organized and stored. The information stored in a tuple is associated with a principal, which can represent a user, a group, an application, an entity, or a device, that owns the tuple. Each tuple can be identified by a tuple identifier (ID), e.g., a uniform resource identifier (URI) or uniform resource locator (URL), and the principal can publish information to its associated tuple using the tuple ID.

An entity interested in receiving information published by a principal can subscribe to the principal's associated tuple by providing the tuple ID. When the principal publishes updated information identifying the tuple to be created or updated, the pub/sub service updates the tuple information and transmits the updated information to all interested entities, i.e., subscribers, via notification messages. The published information can be read simultaneously by any number of subscribers. So long as the subscriber remains subscribed to the tuple, the subscriber can continue to receive notification messages corresponding to the tuple principal's postings. Some pub-sub services can support filters that restrict the set of subscribers to whom updated information is transmitted.

Notably, as is used herein, the term “publish/subscribe” refers to the class of services and associated protocols where a subscribing client knows the tuple identifier, and thus the principal, of the tuple for which a subscription is to be established. Similarly, the publishing client knows the tuple identifier of the tuple to which it is publishing information, and can specify to which watching principals the tuple information should be sent, e.g., in a directed Publish or Notify. The subscriber receives only the most recently published information in a notification message resulting from a subscription. That is, the pub/sub service transmits to the subscriber only the most current state of the published information in response to new and/or updated tuple information.

In contrast to other services, the pub/sub services as described herein are not topic or content based subscription services. In topic based subscription services, sometimes also referred to as pub/sub services, publishers do not publish to identified tuples, nor do subscribers subscribe to tuples of identified principals. Publishers and subscribers can be anonymous. Depending on the variant of this type of service, publishers publish information to nowhere in particular allowing the service to examine the content of the information, and distribute it to subscribers based on content filters included in their subscriptions to an identified topic, an identified class, and/or an identified type. While sometimes referred to as pub/sub services, such topic and content based subscription services do not fall within the scope of the pub/sub services described herein.

As mentioned above, existing pub/sub services allow a publisher to publish information to its associated tuple and to specify to whom the published information should be directed. This feature is referred to as a “directed publish,” and is useful in many situations. For example, when the published information is a request for a specified service, the publisher can also identify a recipient that provides the specified service so that the tuple information, i.e., the request, can be sent directly to the service providing recipient. In this case, the service providing recipient receives a notification message including the request regardless of whether the recipient is subscribed to the publisher's tuple.

When tuple information is directly published to a specified recipient, the identity of the recipient is typically known to the publisher. When the identity of the recipient is not known, however, the scenario can be problematic. For example, if a notify message including the request is sent to all subscribers, it can be meaningless to some, cause errors in some, and/or expose confidential information inappropriately to some. Moreover, such broad distribution can result in unnecessary messages sent by recipients that are unsuitable from the perspective of the publisher and/or some other management agent.

### SUMMARY

Methods, systems and computer program products are described for dynamically binding a watching principal to a tuple. The methods, systems, and computer program products allow a publisher of tuple information to publish the information to a watcher that satisfies a matching criterion without having prior knowledge of the watcher's identity. Conversely, a principal represented by a watcher can be directly notified of relevant tuple information regardless of whether the watcher is subscribed to the updated tuple. In one aspect, a system for dynamically binding a watching principal to a tuple comprises system components including a message router component configured to receive a watcher matching criterion to bind a watcher representing a principal to a tuple, and an attribute manager component configured to receive an attribute of a first principal represented by a first watcher in a publish/subscribe client. The system also includes a matcher component that is configured to determine whether the first watcher satisfies the watcher matching criterion when an update to a tuple is detected, where the determination is based on an evaluation of the watcher matching criterion and the attribute of the first principal, and a binder component configured to bind the first watcher to the updated tuple by providing at least a portion of the updated tuple information to the first watcher when the matching criterion is satisfied.

In another aspect of the subject matter disclosed herein, a system for dynamically binding a watching principal to a tuple comprises system components including a management service component configured to determine a watcher matching criterion for binding a watcher representing a principal to a tuple, a service agent component configured to generate a message including the matching criterion, and a protocol service agent component configured to send the message to a publish/subscribe service node configured to host a service for managing a plurality of data tuples. The service is configured to determine, in response to an update of a tuple, whether a watcher associated with a principal satisfies the watcher matching criterion based on an evaluation of the matching criterion and an attribute of the principal, and to bind the watcher to the updated tuple when the matching criterion is satisfied so that at least a portion of updated tuple information is provided to the watcher.

In another aspect of the subject matter disclosed herein, a method and a computer readable medium storing a computer program, executable by a machine, for dynamically binding a watching principal to a tuple includes executable instructions for receiving a watcher matching criterion to bind a watcher to a tuple, where the watcher represents a principal, receiving an attribute of a first principal represented by a first watcher in a publish/subscribe client, determining whether the first watcher satisfies the watcher matching criterion when an update to a tuple is detected, where the determination is based on an evaluation of the watcher matching criterion and the attribute of the first principal, and binding the first watcher to the updated tuple by providing at least a portion of the updated tuple information to the first watcher when the matching criterion is satisfied.

In another aspect of the subject matter disclosed herein, another method and a computer readable medium storing a computer program, executable by a machine, for dynamically binding a watching principal to a tuple includes executable instructions for determining a watcher matching criterion for binding a watcher representing a principal to a tuple, generating by a service agent representing a principal a message including the matching criterion, and sending by a protocol service agent the message to a publish/subscribe service node configured to host a service for managing a plurality of data tuples.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a flow diagram illustrating a method for dynamically binding a watching principal to a tuple according to an exemplary embodiment;

FIG. 2 is a block diagram illustrating a system for dynamically binding a watching principal to a tuple according to an exemplary embodiment;

FIG. 3 is a block diagram illustrating another system for dynamically binding a watching principal to a tuple according to another exemplary embodiment;

FIG. 4 illustrates a network in which a system for dynamically binding a watching principal to a tuple can be implemented;

FIG. 5 a flow diagram illustrating another method for dynamically binding a watching principal to a tuple according to another exemplary embodiment;

FIG. 6 is a block diagram illustrating a system for implementing the method of FIG. 5 according to an exemplary embodiment; and

FIG. 7 is a block diagram illustrating another system for implementing the method of FIG. 5 according to another exemplary embodiment.

### DETAILED DESCRIPTION

The subject matter presented herein allows the dynamic binding of a watcher to a tuple based on a watcher matching criterion. Advantageously, a best fit watcher can receive updated tuple information and the tuple's publisher does not need to direct the publish message to any particular watcher. Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described. Various embodiments are described herein. The subject matter may be implemented using one of the embodiments described, any combination of the embodiments described including all of the embodiments, one of the embodiments described herein with other forms not described or any combination of the embodiments described including all of the embodiments with other forms not described.

According to an embodiment, a pub/sub communication architecture and its underlying messaging protocol allow published information to be sent to a subscriber as it is received, in many instances, substantially in real-time in relation to the publication of the information. Information is published within the pub/sub communication architecture using a publish command. The published information can then be communicated to a subscriber using a notify command. The notify command can either include the published information or can provide a reference to the published information.

By way of example, aspects of an embodiment described here can employ a presence protocol as the pub/sub communications protocol. It should be understood, however, the relevant techniques described here can be performed using any pub/sub communications protocol as defined herein. Additionally, the exemplary embodiment described herein is not limited to the use of a pub/sub protocol for all communications described. Other known protocols can also be used.

The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al, titled “Extensible Messaging and Presence Protocol (XMPP): Instant Messaging and Presence,” each of which are published and owned by the Internet Society and are hereby incorporated by reference in their entirety. A pub/sub protocol, as defined herein, includes any protocol meeting the requirements for a presence protocol as specified in RFC 2779 with the exception that there are no requirements for the content of a pub/sub tuple. That is, a pub/sub tuple is not required to support any particular content, such as status and contact means, as required by RFC 2779 for a presence protocol. Publish and notify messages identify the updated tuple and thus identify the publishing principal. Subscribe messages identify the subscriber.

Generally speaking, one or more service nodes are used to provide pub/sub services. The function of a service node, however, can be incorporated, either in whole or in part, into other entities. For example, the presence service model can be used. The presence service model described in RFC 2778 describes two distinct agents of a presence service client. The first of these agents, called a “presentity” (combining the terms “presence” and “entity”), provides presence information to be stored and distributed throughout the presence service on behalf of a presence client. The second type of presence agent is referred to as a “watcher.” Watchers receive presence information from a presence service on behalf of a presence client.

Users of the presence service are referred to, in the presence model described in RFC 2778, as principals. Typically, a principal is a person or group that exists outside of the presence model. A principal can also be a software component, a hardware component, or other resource capable of interacting with the presence service. A principal can interact with the presence system through a “presence user agent” (PUA) or a “watcher user agent” (WUA). As in the case of the presentity and watcher clients with which these service clients interact, the presence and watcher user agents can be combined functionally as a single user agent having both the characteristics of the presence and watcher user agents. User agents can be implemented such that their functionality exists within a presence service, external to a presence service, or a combination of both. Similar statements can be made about presentities and watchers.

As mentioned above, a pub/sub service typically stores and organizes published information into tuples. A tuple can represent any element used to store the published information associated with a resource, e.g., a publisher/principal. The published information may include general contact information for the network resource, such as a name, a telephone number, an email address, a postal address, and IP addresses or URLs associated with the resource, and the like, as well as other data or content. As used here, the tuple can also be a representation that maps field names to certain values to indicate that an entity or object (e.g., the principal) includes certain components, information, and/or perhaps has certain properties.

According to aspects of an embodiment described herein, a pub/sub service is configured to bind a watcher representing a principal to a tuple based on a matching criterion and an attribute of the principal. In one embodiment, the pub/sub service is configured to receive a watcher matching criterion to bind a watcher to a tuple, and to receive an attribute of a principal represented by a watcher in a pub/sub client. In one embodiment, the watcher matching criterion can be received from a publishing principal of a tuple for which a watcher is to be determined, from a principal that is not the principal of the tuple for which a watcher is to be determined, and/or from a potential watching principal for a specific tuple.

When an update to a tuple is detected, the pub/sub service is configured to determine, in one embodiment, whether the watcher satisfies the matching criterion based on an evaluation of the matching criterion and the attribute of the principal represented by the watcher, and to bind the watcher to the updated tuple when the matching criterion is satisfied. In binding the watcher to the updated tuple, at least a portion of the updated tuple information is provided to the watcher. In this manner, the publisher of the tuple information can directly publish the information to a matching watcher without having prior knowledge of the watcher's identity, and the principal represented by the watcher can be directly notified of relevant tuple information regardless of whether the watcher is subscribed to the updated tuple.

The advantages of binding a watching principal to a tuple based on an attribute of the principal and a matching criterion are significant. For example, a watching principal can be configured to perform an operation in response to receiving a notification including information from a tuple bound to the watching principal based on the matching criterion. The operation can be included in or otherwise associated with a number of tasks and/or processes such as, for example, supply chain management, help desk support, and/or loosely coupled programs that make a remote procedure call. Other tasks/processes associated with the operation of the watching principal can include allocating work for concurrent execution among processors and nodes, and/or sales and auctions. Advantageously, the pub/sub service can be configured to manage the multitude of tasks and processes, rather than designing a separate type of system for each task or process.

Moreover, the system is robust in that multiple levels of matching criteria can be specified so that when no watching principal satisfies a preferred criterion, the system can be configured to identify a watching principal with an attribute that matches a fall-back or secondary matching criterion. As many levels as needed can be supported. The level of matching can be reported to the publishing principal and other interested parties. For example, if a performance criterion cannot be met at the preferred level, notifications of published information can be sent to a watching principal that satisfies a secondary level and the interested parties can be notified. The binding for a portion of a tuple can itself be associated with a tuple having a status indicating the level of satisfaction, frequency, and various other real-time data and/or statistical data.

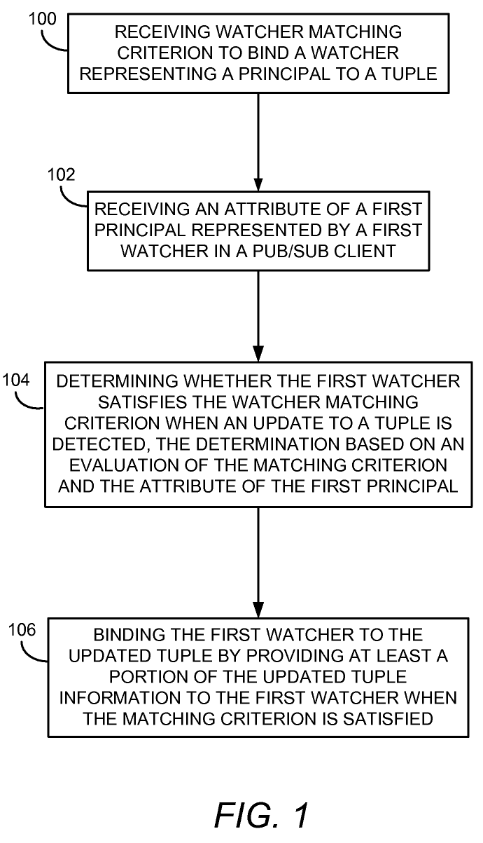

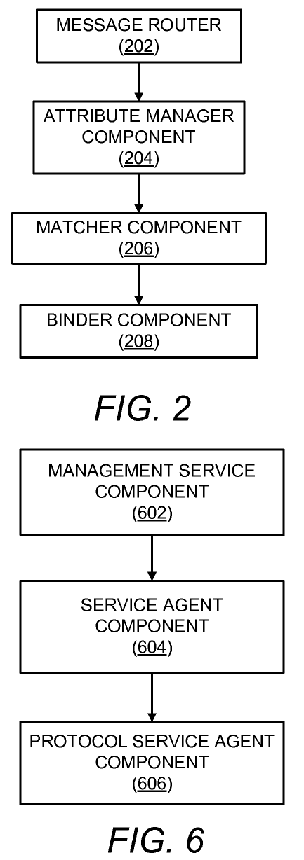

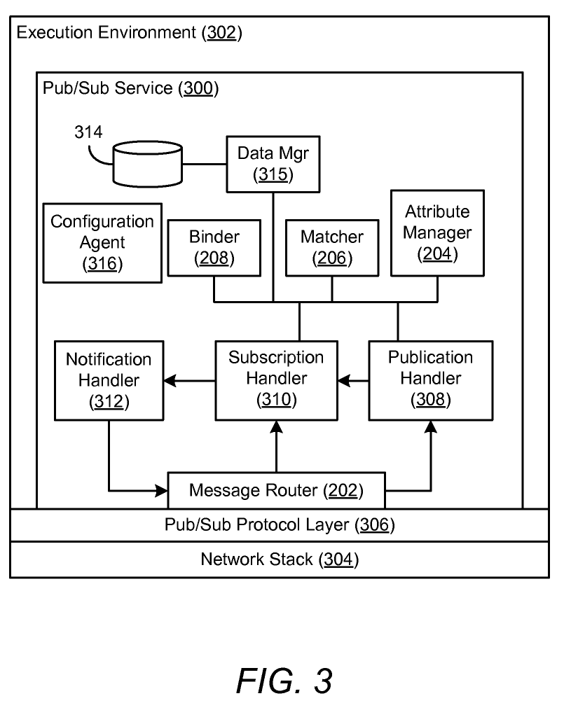

FIG. 1 is a flow diagram illustrating a method for binding a watching principal to a tuple according to an exemplary embodiment. FIGS. 2 and 3 are block diagrams illustrating systems for dynamically binding a watching principal to a tuple according to embodiments of the subject matter described herein. In particular, FIG. 2 illustrates a an arrangement of components configured to bind a watching principal to a tuple, while FIG. 3 illustrates the components of FIG. 2 and/or their analogs adapted for operation in an execution environment provided by a node for binding a watching principal to a tuple. The method illustrated in FIG. 1 can be carried out by, for example, by at least some of the components in each of the exemplary arrangements of components illustrated in FIGS. 2 and 3.

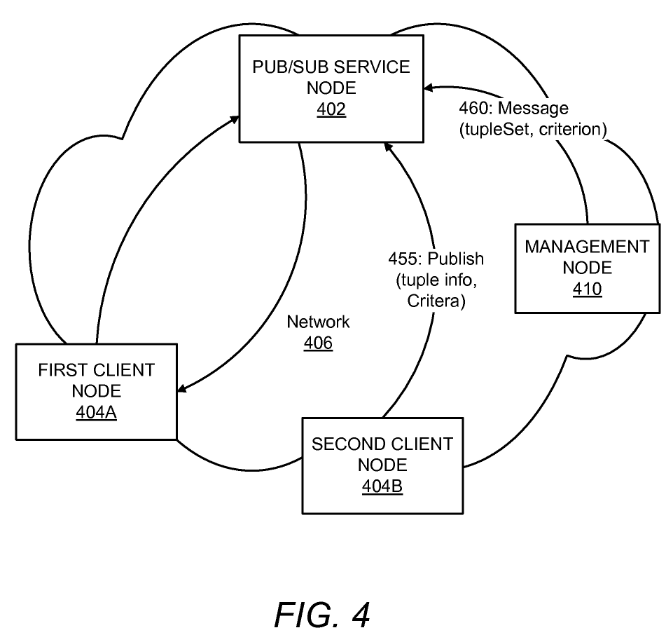

FIG. 2 illustrates an arrangement of components that are configured to operate within an execution environment hosted by a node and/or multiple nodes, as in a distributed execution environment. For example, in FIG. 4, which illustrates a plurality of nodes communicatively coupled to one another via a network 406 such as the Internet, a pub/sub service node 402 can be configured to provide an execution environment configured to support the operation of the components illustrated in FIG. 2 and/or their analogs. Exemplary nodes can include desktop computers, servers, networking nodes, notebook computers, PDAs, mobile phones, and digital image capture devices.

An execution environment can include a memory for storing components and an instruction processing component, such as processor and/or a digital signal processor (DSP), for processing instructions and any data associated with the operation of the components illustrated in FIG. 2. The components illustrated in FIG. 2, and functionally analogous components, each can require or otherwise make use of additional hardware and/or software subsystems according to their particular operational configurations. For example, a network subsystem can be included in the execution environment for enabling communication between nodes over the network 406. An operating system, a persistent data storage subsystem, a memory management subsystem, and/or a process scheduler are other examples of components that can be required for various adaptations of the components illustrated in FIG. 2 and their functional analogs for performing the method in FIG. 1.

Illustrated in FIG. 3 is a pub/sub service 300 including the components illustrated in FIG. 2 adapted for operating in an execution environment 302. The execution environment 302, or an analog, can be provided by a node such as the pub/sub service node 402. The pub/sub service 300 can include a data store 314 for storing tuples and/or other data objects. In one embodiment, the tuples can be presence tuples that include a status element corresponding to a principal's status, and the pub/sub service 300 can be a presence service. The pub/sub service 300 can be configured to receive and send information from and to client nodes 404a, 404b via a network 406 using a pub/sub communications protocol, such as a presence protocol. The network 406 may be a Local Area Network (LAN) and/or a Wide Area Network (WAN) including the Internet.

With reference to FIG. 1, in block 100 a watcher matching criterion is received to bind a watcher representing a principal to a tuple. According to an embodiment, a system for dynamically binding a watching principal to a tuple includes means for receiving a watcher matching criterion to bind a watcher to a tuple, where the watcher represents a principal. For example, FIG. 2 illustrates a message router component 202 for receiving a watcher matching criterion to bind a watcher to a tuple.

According to an embodiment, the watcher matching criterion can be received in a message from a node, such as a second client node 404b. The message can be transmitted over a network 406 and received by a network stack 304 in the execution environment 302. In one embodiment, the message can be formatted according to a pub/sub protocol, such as a presence protocol. The network stack 304 can be configured to provide the message to a pub/sub protocol layer 306 illustrated in FIG. 3. The message router 202 can receive the message from the pub/sub protocol layer 306. The message can be any message supported by the pub/sub protocol layer 306.

Alternatively or additionally, the matching criterion can be received in a message not compatible with a pub/sub protocol. For example, the message can be formatted specifically for exchanging a matching criterion and can be received via a TCP or UDP protocol layer supported by a network stack 304. The matching criterion can be received in other protocols including HTTP and derivatives of HTTP such as SOAP, a management protocol such as SNMP, a LAN protocol such as NetBIOS, and/or a link layer protocol such as IEEE 802.3 or 802.11. In another embodiment, the matching criterion can be received by a message router 202 configured to route the matching criterion entered, selected, or otherwise received from a user via a user interface. Still further, the matching criterion can be received by a message router 202 configured to receive the matching criterion from a data storage device, for example, as configuration data for a pub/sub service 300.

According to one embodiment, the watcher matching criterion can identify restrictions on watchers to be sent a notification including published tuple information. For example, a publishing principal can publish a request to a tuple via a PUA and a presentity representing the principal. The request can be a request that cannot and/or should not be processed by all subscribers to the tuple of the publishing principal. For instance, the request can be a remote procedure call for sorting a list or performing a directory lookup. A request to sort a list should be sent to a watcher in a node, such as the first client node 404a, that includes an application configured to sort a list.

The publishing client of the requesting principal can implicitly and/or explicitly identify restrictions on watchers to be sent a notification including the published request information. The restrictions can be received as one or more watcher matching criterion. For example, the watcher matching criterion can be based on a security interest when the requesting principal belongs to a group, such as a company, having a security policy requiring principals represented by watchers to satisfy certain security conditions in order to be bound. In one embodiment, the watcher matching criterion can be based on an attribute of a watching principal. In this case, a watching principal can have an attribute indicating the principal belongs to the same group as the publishing principal and/or certifying the watching principal as an authorized service provider, for example. The watcher matching criterion can require the watching principal to have an attribute indicating the principal has been authenticated.

In another embodiment, the watcher matching criterion for receiving a notification can be based on a performance criterion that must be satisfied by a watching principal. In the request/response interaction described above, a watching principal that provides list sorting services can have an attribute that satisfies a performance criterion for a list of 100 entries, but does not satisfy a criterion that exceeds 100 entries. In one embodiment, the matching criterion can be absolute and/or can be relative to other watching principals.

According to an embodiment, a watcher matching criterion can be associated with no particular tuple or principal depending on the configuration of the pub/sub service 300. Alternatively, a watcher matching criterion can be associated with a tuple and/or a specified principal based on a tuple identifier of the principal. The watcher matching criterion can also be associated with a specified set of principals and their respective tuples. The set of principals can be identified by a group identifier and/or any attribute associated with a tuple for identifying tuples to be associated with the matching criterion. Exemplary attributes for associating the tuple with a matching criterion include location information included in a tuple, a schema for identifying valid tuples according to the schema, a job or role function, a principal type, and/or other identifying characteristics. The association of the watcher matching criterion with one or more tuples can be configured to be performed at the time the watcher matching criterion is received or in response to an update to a tuple and/or an associated attribute. The association can be persistent until explicitly cancelled or can be modified based on detected changes to a tuple and/or an associated attribute.

According to one embodiment, when the watcher matching criterion is received in a message from a node, such as the first client node 404a, the message can be a subscribe message. For example, the message can include a subscription request where the subscription information identifies a watching principal that is a watcher in the first client node 404a sending the message, or a watcher in another node, such as the second client node 404b. The message can also include the watcher matching criterion for binding the identified watching principal to a tuple. In another embodiment, the message can be a publish message, such as that discussed above, that includes a request for a specified service.

In another embodiment, the watcher matching criterion can be received with tuple information for updating a tuple. For example, the matching criterion can be received in a publish message including the tuple information for updating a tuple, and/or can be received in a separate message from the publishing principal's presentity along with the publish message where the separate message can be associated with the publish message with a message correlator. Alternatively or additionally, the matching criterion can be received from a watching principal, such as a system manager, in response to receiving a notification sent in response to a tuple update. Still further, the matching criterion can be received from the pub/sub service 300 based on information included in tuple information, past or current, in the data store 314. The tuple information can be associated with the publishing principal or another principal, and/or based on configuration information such as policy information evaluated in response to detecting an update to a tuple.

In another embodiment, the matching criterion can be determined by a component in the pub/sub service 300. The component, e.g., a matcher component 206, can be configured to determine the matching criterion based on a set of rules or a learning component including a neural net and/or utilizing Bayesian statistics to optimize matching. For example, a criterion for matching Request for Quotes (RFQs) with bidders can be based on a satisfaction metric associated with a bidder or set of bidders to optimize the cost per unit of satisfaction. The matcher component 206 can be configured to add, and/or remove attributes for matching, and/or adjust thresholds based on receiving actual cost per unit of satisfaction metrics that exceed, equal, or fall below the projected optimum.

The watcher matching criteria and the messages described above are exemplary and those skilled in the art will understand that they are not intended to provide an exhaustive list and/or description of either.

Returning to FIG. 1, in addition to receiving the watcher matching criterion, in block 102 an attribute of a first principal represented by a first watcher in a pub/sub client is received. According to an embodiment, the system for binding a watching principal to a tuple includes means for receiving an attribute of a first principal represented by a first watcher in a pub/sub client. For example, FIG. 2 includes an attribute manager component 204 configured for receiving an attribute of a first principal represented by a first watcher in a pub/sub client.

According to an embodiment, the attribute of the first principal represented by the first watcher can include, for example, the principal's location, role or job title, domain of a contact address, and/or status. In addition, the attribute can include a relation to a publishing principal, e.g., family, business, or community, age, gender, contact information, health attributes, and/or political attributes. Because a principal can also be a service or system, the attribute can include a service identifier or type, attributes of parameters accepted, attributes of a result or output of a service, and/or a schema associated with any attribute of a service. Additional exemplary attributes can include: a cost of processing a notification by a watching principal or surrogate where cost can be measured in any number of ways, e.g., money and/or time; a reliability rating measured by actual performance or subjectively rated; a speed rating; an order in a set of watching principals; an environmental rating, e.g., energy cost and/or CO² emission amount; and any other category or trait.

In one embodiment, the attribute manager component 204 can be configured to receive the attribute of the first principal represented by the first watcher in information sent by the first principal to update a tuple of the first principal via a pub/sub protocol message and/or via a message of another type of protocol including a request/response protocol and/or a protocol supporting an unsolicited, asynchronous message. For example, when the attribute of the first principal is included in a publish message updating a tuple of the first principal, the message can be received by the message router 202 in the pub/sub service 300 and routed to the attribute manager component 204 via the publication handler component 308.

In another embodiment, the attribute manager component 204 can be configured to receive the attribute in a message sent by a second principal, e.g., in a subscribe message. In this case, when the attribute of the first principal is included in a subscribe message, the message can be received by the message router 202 in the pub/sub service 300 and routed to the attribute manager component 204 via the subscription handler component 310. Alternatively or additionally, the attribute of the first principal can be read from a storage device via a data store client component (not shown), received from a user via a user interface component (not shown), and/or determined by a pub/sub service 300 based on a communication with the first principal and/or determined indirectly based on a communication with related principals and/or other communication partners.

In FIG. 3, the attribute manager component 204 is illustrated as a separate component. In other embodiments, the attribute manager component 204 can be included in the publication handler component 308 and/or in the subscription handler component 310. The attribute manager component 204 can be configured to receive and/or detect the attribute of the first principal, to store the attribute, and to create an association between the attribute and one or more tuples. In some embodiments, the association can be created when the attribute is received and/or when a tuple is updated.

Returning to FIG. 1, once the watcher matching criterion and the attribute of the first principal are received, in block 104 a determination is made as to whether the first watcher satisfies the watcher matching criterion when an update to a tuple is detected, where the determination is based on an evaluation of the watcher matching criterion and the attribute of the first principal. According to an embodiment, a system for dynamically binding a watching principal to a tuple includes means for determining whether the first watcher satisfies the watcher matching criterion based on an evaluation of the watcher matching criterion and the attribute of the first principal when an update to a tuple is detected. For example, FIG. 2 includes a matcher component 206 configured for determining whether the first watcher satisfies the watcher matching criterion when an update to a tuple is detected, the determination based on an evaluation of the watcher matching criterion and the attribute of the first principal.

According to one embodiment, an update to a tuple can update an existing element of a tuple, create a new tuple, add a new subtuple and/or delete a subtuple to and/or from an existing tuple, and/or delete an entire tuple of a principal. In one embodiment, the update can be detected by the publication handler component 308, the subscription handler component 310, a data manager 315 and/or a notification handler component 312. For example, a tuple update can be detected by the publication handler 308 in response to receiving a publish message including tuple information for updating the tuple. The message can be received from the message router 202 via the network stack 304 and pub/sub protocol layer 306 provided by the execution environment 302. The network stack 304 receives the message via a network 406. For instance, in FIG. 4, the second client node 404b is shown sending a publish message 455 to the pub/sub service node 402 which can be configured to provided the execution environment 302 including the components illustrated in FIG. 3.

In another example, the data manager 315 of the data store 314 can also detect an update to the tuple when it receives tuple information from the publication handler 308 along with an identifier of the tuple. The data manager 315 can be configured to update and/or allocate a storage location for storing at least a portion of the identified tuple based on the received tuple information. Additionally, the subscription handler 310 can be configured to detect an update to the identified tuple. The subscription handler 310 can be notified that the tuple has been updated by the publication handler 308 and/or by the data manager 315. Alternatively, the subscription handler 310 can be configured to monitor the tuple by, for example, fetching tuple information from the tuple via the data manager 315 and comparing the retrieved information against previously fetched data and/or by intercepting a communication between the publication handler 308 and the tuple manager 315 that includes an indication to update the tuple or that the tuple has been updated. Additionally, the notification handler 312 can be configured to detect an update to a tuple when the notification handler 312 is invoked to send a notification including updated tuple information.

According to one embodiment, the matcher component 206 can be invoked by the publication handler 308, the subscription handler 310, and/or any component configured to detect the tuple update when an update is detected. When invoked, the matcher component 206 is configured to determine whether the first watcher representing the first principal satisfies the watcher matching criterion based on an evaluation of the watcher matching criterion and the attribute of the first principal. Alternatively or additionally, the matcher component 206 can be configured to make this determination in response to a specific request to do so from a principal associated with the updated tuple, the first principal, a watching principal, and/or from a component of the pub/sub service 300 based on detecting an event and/or state of the pub/sub service 300 according to a configuration of the pub/sub service 300. In this case, the request would not be a subscription request, and the matching criterion would not be an identifier of the updated tuple.

In addition, the determination can be made in response to receiving an update to the matching criterion, receiving updated attribute information associated with the first principal, and/or detecting an event based on an attribute of time. For example, the matcher component 206 can be configured to make the determination every 60 minutes. In other cases, the determination can be made in response to detecting a change in metadata associated with a tuple or a principal. For example, such a change can include a change in an attribute associated with a tuple and/or its principal, but not included in the tuple, such as statistics and/or other metadata associated with the principal maintained and/or determined by the pub/sub service 300.

According to an embodiment, the matcher component 206 can be configured to determine whether other watchers, in addition to the first watcher, representing other principals satisfy the watcher matching criterion based on evaluating the attributes of the other watchers and the matching criterion. In addition, the matcher component 206 can be configured to make the determination based on a ranking produced in response to evaluating the matching criterion. In one example, the ranking can match a threshold and/or be either greater than the threshold or less than the threshold. In some cases, the matcher component 206 can be configured to identify a single watcher that satisfies the watcher matching criterion, which can be an initial watcher or a best watcher that satisfies the criterion.

Referring again to FIG. 1, when the watcher matching criterion is satisfied, in block 106 the first watcher is bound to the updated tuple and at least a portion of the updated tuple information is provided to the first watcher. According to an embodiment, a system for dynamically binding a watching principal to a tuple includes means for binding the first watcher to the updated tuple by providing at least a portion of the updated tuple information to the first watcher when the matching criterion is satisfied. For example, FIG. 2 includes a binder component 208 configured for binding the first watcher to the updated tuple by providing at least a portion of the updated tuple information to the first watcher when the matching criterion is satisfied.

According to an embodiment, the binder component 208 can be configured to provide for generating a notification to be sent to the first watcher representing the first principal. For example, the binder component 208 can be configured to interoperate with the notification handler component 312 for generating a notification including at least a portion of the updated tuple information in a notification message. The notification message can be provided to the message router component 202 by the notification handler component 312 for sending to the first principal. For example, the message router component 202 can be configured to interoperate with the pub/sub protocol layer 306 for sending the updated tuple information to the first watcher representing the first principal, e.g., associated with the first client node 404a, in a message formatted according to the configured pub/sub protocol via the network protocol stack 304 and the network 406. In one embodiment, the notification can be sent only when the first watcher is actively subscribed to the updated tuple, while in another embodiment, the first watcher need not be actively subscribed the tuple in order to receive notifications.

Alternatively or additionally, when the first watcher satisfies the matching criterion, the binder component 208 can be configured to provide for establishing, for the first watcher, a subscription to at least the updated portion of the updated tuple. For example, binder component 208 can be configured to send a request to the subscription handler 310 for establishing, for the first watcher, a subscription to the updated tuple. In one embodiment, the subscription handler 310 can be configured to add an identifier associated with the first principal to a subscription list associated with the updated tuple as a whole or in part.

Once the first watcher is bound to the updated tuple, the first watcher can be permitted to establish a communication session with the principal of the updated tuple. The communication session can be established via the pub/sub service 300 using pub/sub protocols. The communications can include exchanging data via the updated tuple, a tuple of the watching principal, and/or a shared tuple provided by the pub-sub service 300. Alternatively or additionally, the first watcher can be permitted to communicate with the principal and/or an agent of the principal via any other suitable protocol.

According to an embodiment, the binding between the first watcher and the updated tuple can be persistent until terminated, e.g., in response to a request from the first watcher and/or the principal associated with the updated tuple. The binding between the first watcher and the updated tuple can also be dynamic. For example, when the watcher matching criterion is updated and the matcher component 206 determines that the first watcher no longer satisfies the updated watcher matching criterion, the binder component 208 can be configured to unbind the first watcher to the updated tuple. Similarly, when the attribute of the first principal is updated and the matcher component 206 determines that the first watcher no longer satisfies the watcher matching criterion, the binder component 208 can be configured to unbind the first watcher to the updated tuple. In addition, the binding between the first watcher and the updated tuple can be affected by other events, such as another update to the tuple, an update/creation of another tuple, receiving new attribute information associated with a watcher, and/or a result of an evaluation of the matching criterion based on an attribute of time.

In one embodiment, the binder component 208 can be further configured to prevent a watcher that does not satisfy the matching criterion from subscribing to the tuple. Alternatively, the binder component 208 can be configured to allow the watcher to subscribe to the tuple, but prevent the watcher from receiving updated tuple information associated with the matching criterion.

The method illustrated in FIG. 1 has been described above in the context of the components illustrated in FIG. 2 operating in an execution environment 302 provided by a pub/sub service node 402. In another embodiment, the method of FIG. 1 can also be carried out by components in a client node, e.g., the second client node 404b, interoperating with the pub/sub service node 402. For example, a pub/sub client in the client node 404b can receive the watcher matching criterion and an attribute of a first principal via a user interface, a watcher receiving a notification including a matching criterion and/or attribute published to a tuple, and/or other means described above. The pub/sub client can detect an update to a tuple via a notification from the pub/sub service node 402 or indirectly via a message using any suitable protocol sent from another pub/sub client, or any suitable message sent from a pub/sub service node 402. The pub/sub client can be configured to determine that the first principal satisfies the watcher matching criterion, and can send a message using any suitable protocol to the pub/sub service node 402 causing at least a portion of the updated tuple to be sent to the first principal. Alternatively, the pub/sub client can bypass the pub/sub service node 402 and send at least a portion of the updated tuple information to the first principal.

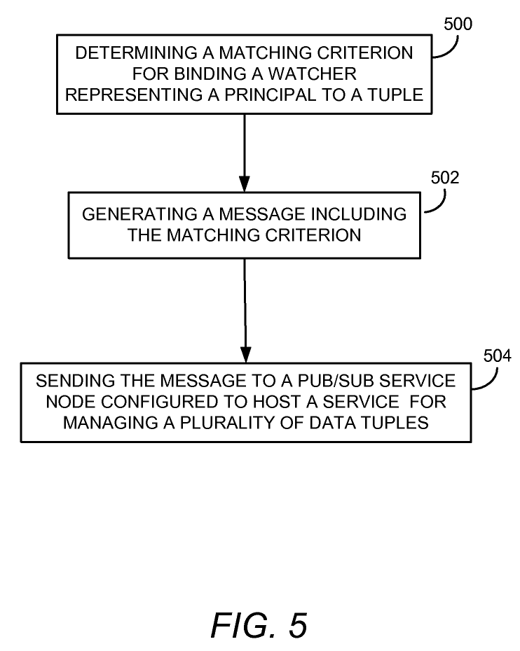

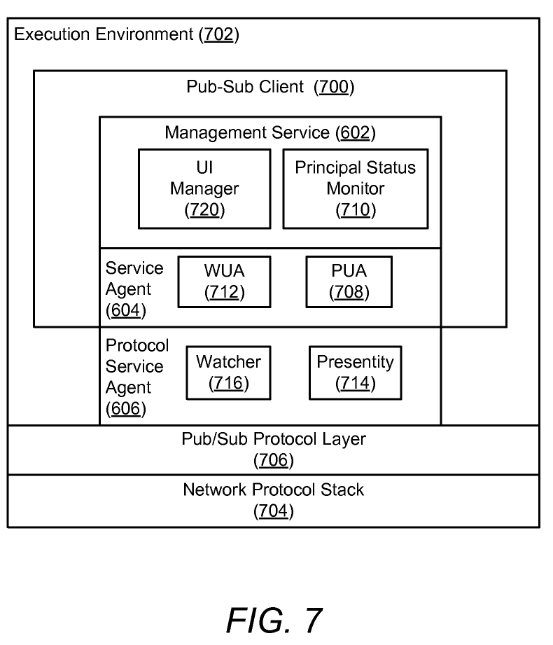

FIG. 5 is a flow diagram illustrating a method for dynamically binding a watching principal to a tuple according to another aspect of the subject matter described herein. FIGS. 6 and 7 are block diagrams illustrating systems for binding a watching principal to a tuple according to other embodiments. In particular, FIG. 6 illustrates components configured for binding a watching principal to a tuple, while FIG. 7 illustrates the components of FIG. 6 and/or their analogs adapted for operation in an execution environment provided by a node for binding a watching principal to a tuple. The method illustrated in FIG. 5 can be carried out by, for example, by at least some of the components in each of the exemplary arrangements of components illustrated in FIGS. 6 and 7.

The components illustrated in FIG. 6 are configured to operate within an execution environment hosted by a node and/or multiple nodes. For example, in FIG. 4, a client node, such as the second client node 404b can be configured to provide an execution environment configured to support the operation of the components illustrated in FIG. 6 and/or their analogs.

Illustrated in FIG. 7 is a pub/sub client 700 including the components illustrated in FIG. 6 adapted for operating in an execution environment 702. As mentioned above, the execution environment 702, or an analog, can be provided by a node such as the second client node 404b, or by a management node 410 hosting a management application for configuring the pub/sub service 300 hosted by the pub/sub service node 402. The pub/sub client 700 operating in the client node 404b or in the management node 410 can be configured to receive and send information from and to other client nodes 404a and the pub/sub service node 402 via the network 406 using a pub/sub communications protocol, such as a presence protocol.

With reference to FIG. 5, in block 500 a watcher matching criterion is determined for binding a watcher representing a principal to a tuple. According to an exemplary embodiment, a system for binding a watching principal to a tuple includes means for determining a watcher matching criterion for binding a watcher representing a principal to a tuple. For example, FIG. 6 illustrates a management service component 602 configured to determine a watcher matching criterion for binding a watcher representing a principal to a tuple.

In one embodiment, the management service component 602 can include a user interface manager component 720 configured to receive the matching criterion from a user via an input device of a hosting node, e.g., the client node 404b or the management node 410. Alternatively or additionally, the management service component 602 can receive the watcher matching criterion from a message sent from a client node 404a and/or an application, and/or from configuration data in a local data store (not shown).

As mentioned above, the watcher matching criterion can be used to identify restrictions on watchers to be sent a notification including published tuple information. For example, the watcher matching criterion can be based on a security interest and/or on an attribute of a watching principal. The watcher matching criterion can also be based on a performance criterion that must be satisfied by a watching principal. In one embodiment, the management service component 602 can be configured to determine the watcher matching criterion based on an existing matching criterion, a set of rules, and/or a learning component including a neural net to optimize matching. For example, a criterion for matching RFQs with bidders can be based on a satisfaction metric associated with a bidder or set of bidders to optimize cost per unit of satisfaction. The management service component 602 can be configured to add, and/or remove attributes for matching, and/or adjust thresholds based on receiving actual cost per unit of satisfaction that exceeds, equals, or falls below the projected optimum.

According to one embodiment, the management service component 602 can be configured to determine an association between the watcher matching criterion and a tuple representing a principal. The association can be based on an attribute of the principal, an identifier of the tuple and/or the principal, a schema of the tuple, and/or a role of the principal. Alternatively, the watcher matching criterion can be associated with a specified set of principals and their respective tuples. The set of principals can be identified by a group identifier and/or any criterion associated with a tuple for identifying tuples to be associated with the matching criterion. Alternatively, the watcher matching criterion can be associated with no particular tuple prior to evaluation of the matching criteria in response to a tuple update.

Referring again to FIG. 5, once the matching criterion is determined, in block 502 a message including the matching criterion is generated. According to an exemplary embodiment, a system for binding a watching principal to a tuple includes means for generating a message including the matching criterion. For example, FIG. 6 illustrates a service agent component 604 configured to generate a message including the matching criterion.

According to an embodiment, the service agent component 604 can be configured to generate a message formatted according to a variety of schemas that support a representation of the matching criterion. For example, in the pub/sub client 700, the service agent component 604 can include a WUA 712 and a PUA 708 configured to generate a subscribe message and a publish message, respectively, that includes the matching criterion. The subscribe and/or publish message can be formatted according to a pub/sub protocol, such as a presence protocol.

In one embodiment, the publish message can be generated to be published to a tuple for receiving a matching criterion. The tuple for receiving the matching criterion can be the tuple of the principal represented by the PUA 708 or another tuple. The publish message can include tuple information for the publishing principal, such as a status and/or a location of the principal provided by a principal status monitor 710. The matching criterion can be included in the same generated publish message as a single tuple or as multiple tuples. Alternatively, the message can be generated in correspondence with generating a message including tuple information for the publishing principal. In this case, the messages can be correlated by including a correlator in each or by correspondence in time. The matching criterion can be provided to the PUA 708 by the UI manager 720 and/or the principal status monitor 710.

In another embodiment, a subscribe message can be generated by the WUA 712. The subscription can include the watcher matching criterion for binding a watcher to a tuple. The watcher can be the watcher of a principal other than the subscriber.

Referring again to FIG. 5, once the message is generated, in block 504 the message is sent to a pub/sub service node configured to host a service for managing a plurality of data tuples. In one embodiment, the service is configured to determine whether a watcher associated with a principal satisfies the watcher matching criterion based on an evaluation of the matching criterion and an attribute of the principal in response to an update of a tuple. Moreover, the service is configured to bind the watcher to the updated tuple when the matching criterion is satisfied so that at least a portion of updated tuple information is provided to the watcher.

According to an exemplary embodiment, a system for binding a watching principal to a tuple includes means for sending the message to a pub/sub service node 402 configured to host a service for managing a plurality of data tuples. For example, FIG. 6 illustrates a protocol service agent component 606 configured to send the message to a pub/sub service node 402 configured to host a service for managing a plurality of data tuples.

The protocol service agent component 606, in one embodiment, can be configured to send the message generated by the service agent component 604 to the pub/sub service node 402 via the network 406 according to a suitable communication protocol, of which a large number exist or can be defined. For example, in the pub/sub client 700, the protocol service agent component 606 can include a watcher 716 and a presentity 714 each configured to support communication via a pub/sub protocol such as a presence protocol.

Either or both of the presentity 714 and the watcher 716 can send the message according to the configuration of the pub/sub client 700. The presentity 714 can send the generated message as a publish message and/or the watcher 716 can send the message as a subscribe message. The message can be provided to the pub/sub protocol layer 706 by either of the watcher 716 or presentity 714 as determined by the configuration of the pub/sub client 700. The pub/sub protocol layer 706 can be configured to package the message for sending. Such packaging can include reformatting the message, breaking the message into packets, including at least a portion of the message along with at least a portion of another message to be transmitted together, and/or adding additional information such as a header or trailer as specified by the protocol used.

While a pub/sub protocol is described, other types of protocols can be used including a request/response protocol such as, for example, HTTP, and/or a protocol supporting an unsolicited, asynchronous message sent to a receiver. For example, the protocol service agent component 606 in the management node 410 can be configured to send the message 460 to the pub/sub service node 402 as a SOAP message, where the SOAP protocol supports both a request/response interaction and an unsolicited asynchronous message. The message 460 can illustrate a SOAP request message in one aspect, and can illustrate a SOAP unsolicited, asynchronous message in another aspect.

In a still further alternative, a configuration agent 316, illustrated in FIG. 3, can be configured to send the message to a component of the pub/sub service 300 configured to receive the message as described above with respect to the method in FIG. 1. For example, the components illustrated in FIG. 6 and their analogs can be adapted for operating in the execution environment 302 provided by the pub/sub service node 402 hosting the pub/sub service 300. One or more of the components in FIG. 6 can be components of the pub/sub service 300 and/or can operate external to the pub/sub service 300. The configuration agent 316 can receive and send the message including the matching criterion to the message router 202 for routing to the publication handler 308, the subscription handler 310, or the notification handler 312 based on the message type. Alternatively, the configuration agent 316 can send the message directly to the publication handler 308, the subscription handler 310, the notification handler 312, and/or the tuple data store 314 for binding a watching principal to a tuple based on an attribute of the principal in response to an update to a tuple.

It should be understood that the various system components (and means) defined by the claims and illustrated in the various block diagrams represent logical components that are configured to perform the functionality described herein. While at least one of these components are implemented at least partially as an electronic hardware component, and therefore constitutes a machine, the other components may be implemented in software, hardware, or a combination of the two. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of the two. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

Moreover, the methods described herein can be embodied in executable instructions stored in a computer readable medium for use by or in connection with an instruction execution machine, apparatus, or device, such as a computer-based or processor-containing machine, apparatus, or device. As used here, a “computer-readable medium” can include one or more of any suitable media for storing the executable instructions of a computer program in one or more of an electronic, magnetic, optical, and electromagnetic, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

The use of the terms “a” and “an” and “the” and similar referents in the context of describing the subject matter (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illuminate the subject matter and does not pose a limitation on the scope of the subject matter unless otherwise claimed. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A system for dynamically binding a watching principal to a tuple, the system comprising system components including:
a message router component configured to receive a watcher matching criterion to bind a watcher representing a principal to a tuple;
an attribute manager component configured to receive an attribute of a first principal represented by a first watcher in a publish/subscribe client;
a matcher component configured to determine whether the first watcher satisfies the watcher matching criterion when an update to a tuple is detected, the determination based on an evaluation of the watcher matching criterion and the attribute of the first principal; and
a binder component configured to bind the first watcher to the updated tuple by providing at least a portion of the updated tuple information to the first watcher when the matching criterion is satisfied,
wherein at least one of the system components includes at least one electronic hardware component.

2. The system of claim 1 wherein the message router component is configured to receive the watcher matching criterion from at least one of a message sent from a client node via a network, a user via a user interface, and configuration data in a local data store.

3. The system of claim 2 wherein the message including the watcher matching criterion is formatted according to a publish/subscribe protocol and is at least one of a notification message, a subscribe message, and a publish message.

4. The system of claim 3 wherein the publish/subscribe protocol is a presence protocol.

5. The system of claim 1 wherein the watcher matching criterion is based on at least one of a security interest, a performance criterion, and an attribute of a principal.

6. The system of claim 1 wherein the matcher component is configured to determine whether the watcher matching criterion is satisfied in response to at least one of a request from at least one of a principal associated with the updated tuple and the first principal, receiving updated attribute information associated with the first principal, and detecting an event based on an attribute of time.

7. The system of claim 1 wherein the binder component is configured to provide for at least one of establishing a subscription to at least an updated portion of the updated tuple, and generating a notification message including at least a portion of the updated tuple information.

8. The system of claim 1 wherein when the watcher matching criterion is updated, the matcher component is configured to determine whether the first watcher satisfies the updated watcher matching criterion based on an evaluation of the updated matching criterion and the attribute of the first principal, and the binder component is configured to unbind the first watcher to the updated tuple when the updated matching criterion is no longer satisfied.

9. The system of claim 1 wherein when the attribute of the first principal is updated, the matcher component is configured to determine whether the first watcher satisfies the watcher matching criterion based on an evaluation of the matching criterion and the updated attribute of the first principal, and the binder component is configured to unbind the first watcher to the updated tuple when the matching criterion is no longer satisfied.

10. A system for dynamically binding a watching principal to a tuple, the system comprising system components including:
a management service component configured to determine a watcher matching criterion for binding a watcher representing a principal to a tuple;
a service agent component configured to generate a message including the matching criterion; and
a protocol service agent component configured to send the message to a publish/subscribe service node configured to host a service for managing a plurality of data tuples,
wherein in response to an update of a tuple, the service is configured to: determine whether a watcher associated with a principal satisfies the watcher matching criterion based on an evaluation of the matching criterion and an attribute of the principal; and bind the watcher to the updated tuple when the matching criterion is satisfied so that at least a portion of updated tuple information is provided to the watcher, and
wherein at least one of the system components includes at least one electronic hardware component.

11. The system of claim 10 wherein the management service component is configured to receive the watcher matching criterion from at least one of a message sent from a client node, a message from an application, a user via a user interface, and configuration data in a local data store.

12. The system of claim 10 wherein the message including the watcher matching criterion is formatted according to a publish/subscribe protocol and is at least one of a subscribe message and a publish message.

13. The system of claim 10 wherein the watcher matching criterion is based on at least one of a security interest, a performance criterion, and an attribute of a principal.

14. The system of claim 10 wherein the message including the matching criterion is correlated with another message including tuple information associated with a principal represented by the service agent.

15. The system of claim 10 wherein the watcher matching criterion is associated with a tuple whose principal is different from a principal represented by the service agent.

16. The system of claim 10 wherein the management service component is configured to determine an association between the watcher matching criterion and a tuple representing a principal, the association based on at least one of an attribute of the principal, an identifier of at least one of the tuple and the principal, a schema of the tuple, and a role of the principal.

17. A system for dynamically binding a watching principal to a tuple, the system comprising:
means for receiving a watcher matching criterion to bind a watcher representing a principal to a tuple;
means for receiving an attribute of a first principal represented by a first watcher in a publish/subscribe client;
means for determining whether the first watcher satisfies the watcher matching criterion when an update to a tuple is detected, the determination based on an evaluation of the watcher matching criterion and the attribute of the first principal; and
means for binding the first watcher to the updated tuple by providing at least a portion of the updated tuple information to the first watcher when the matching criterion is satisfied,
wherein at least one of the means includes at least one electronic hardware component.

18. A system for dynamically binding a watching principal to a tuple, the system comprising:
means for determining a watcher matching criterion for binding a watcher representing a principal to a tuple;
means for generating a message including the matching criterion; and
means for sending the message to a publish/subscribe service node configured to host a service for managing a plurality of data tuples,
wherein in response to an update of a tuple, the service is configured to determine whether a watcher associated with a principal satisfies the watcher matching criterion based on an evaluation of the matching criterion and an attribute of the principal, and is configured to bind the watcher to the updated tuple when the matching criterion is satisfied so that at least a portion of updated tuple information is provided to the watcher,
wherein at least one of the means includes at least one electronic hardware component.

19. A method for dynamically binding a watching principal to a tuple, the method comprising:
receiving a watcher matching criterion to bind a watcher representing a principal to a tuple;
receiving an attribute of a first principal represented by a first watcher in a publish/subscribe client;
determining whether the first watcher satisfies the watcher matching criterion when an update to a tuple is detected, the determination based on an evaluation of the watcher matching criterion and the attribute of the first principal; and
binding the first watcher to the updated tuple by providing at least a portion of the updated tuple information to the first watcher when the matching criterion is satisfied,
wherein at least one of the preceding actions is performed on at least one electronic hardware component.

20. The method of claim 19 wherein the watcher matching criterion is received from at least one of a message sent from a client node via a network, a user via a user interface, and configuration data in a local data store.

21. The method of claim 20 wherein the message including the watcher matching criterion is formatted according to a publish/subscribe protocol and is at least one of a notification message, a subscribe message and a publish message.

22. The method of claim 19 wherein the watcher matching criterion is based on at least one of a security interest, a performance criterion, and an attribute of a principal.

23. The method of claim 19 wherein determining whether the watcher matching criterion is satisfied is in response to at least one of receiving a request to determine from at least one of a principal associated with the updated tuple and the first principal, receiving updated attribute information associated with the first principal, and detecting an event based on an attribute of time.

24. The method of claim 19 wherein binding the first watcher to the updated tuple includes at least one of establishing a subscription for the first watcher to at least an updated portion of the updated tuple, and generating a notification message including at least a portion of the updated tuple information.

25. The method of claim 19 further comprising:
detecting an update to the watcher matching criterion;
determining whether the first watcher satisfies the updated watcher matching criterion based on an evaluation of the updated matching criterion and the attribute of the first principal; and
unbinding the first watcher to the updated tuple when the updated matching criterion is no longer satisfied.

26. The method of claim 19 further comprising:
detecting an update to the attribute of the first principal;
determining whether the first watcher satisfies the watcher matching criterion based on an evaluation of the matching criterion and the updated attribute of the first principal; and
unbinding the first watcher to the updated tuple when the matching criterion is no longer satisfied.

27. A method for dynamically binding a watching principal to a tuple, the method comprising:
determining a watcher matching criterion for binding a watcher representing a principal to a tuple;
generating by a service agent representing a principal a message including the matching criterion; and
sending by a protocol service agent the message to a publish/subscribe service node configured to host a service for managing a plurality of data tuples,
wherein in response to an update of a tuple, the service is configured to: determine whether a watcher associated with a principal satisfies the watcher matching criterion based on an evaluation of the matching criterion and an attribute of the principal; and bind the watcher to the updated tuple when the matching criterion is satisfied so that at least a portion of updated tuple information is provided to the watcher, and
wherein at least one of the preceding actions is performed on at least one electronic hardware component.

28. The method of claim 27 wherein the watcher matching criterion is received from at least one of a message sent from a client node, a message from an application, a user via a user interface, and configuration data in a local data store.

29. The method of claim 27 wherein the message including the watcher matching criterion is formatted according to a publish/subscribe protocol and is at least one of a subscribe message and a publish message.

30. The method of claim 27 wherein the watcher matching criterion is based on at least one of a security interest, a performance criterion, and an attribute of a principal.

31. The method of claim 27 wherein the message including the matching criterion is correlated with another message including tuple information associated with the principal represented by the service agent.

32. The method of claim 27 wherein the watcher matching criterion is associated with a tuple whose principal is different from the principal represented by the service agent.

33. The method of claim 27 further comprising determining an association between the watcher matching criterion and a tuple representing a principal, the association based on at least one of an attribute of the principal, an identifier of at least one of the tuple and the principal, a schema of the tuple, and a role of the principal.

34. A computer readable medium storing a computer program, executable by a machine, for dynamically binding a watching principal to a tuple, the computer program comprising executable instructions for:
receiving a watcher matching criterion to bind a watcher representing a principal to a tuple;
receiving an attribute of a first principal represented by a first watcher in a publish/subscribe client;
determining whether the first watcher satisfies the watcher matching criterion when an update to a tuple is detected, the determination based on an evaluation of the watcher matching criterion and the attribute of the first principal; and
binding the first watcher to the updated tuple by providing at least a portion of the updated tuple information to the first watcher when the matching criterion is satisfied.

35. A computer readable medium storing a computer program, executable by a machine, for dynamically binding a watching principal to a tuple, the computer program comprising executable instructions for:
determining a watcher matching criterion for binding a watcher representing a principal to a tuple;
generating by a service agent representing a principal a message including the matching criterion; and
sending by a protocol service agent the message to a publish/subscribe service node configured to host a service for managing a plurality of data tuples,
wherein in response to an update of a tuple, the service is configured to: determine whether a watcher associated with a principal satisfies the watcher matching criterion based on an evaluation of the matching criterion and an attribute of the principal; and bind the watcher to the updated tuple when the matching criterion is satisfied so that at least a portion of updated tuple information is provided to the watcher.
